(19) United States
(12) Patent Application Publication
(10) Pub. No.: US 2026/0103639 A1
(43) Pub. Date: Apr. 16, 2026

(54) Low-Haze Dye-Doped Liquid Crystal Film

(71) Applicant: Wicue USA INC., Santa Clara, CA (US)

(72) Inventors: Osamu YAMADA, Santa Clara, CA (US); Fenghua LI, Santa Clara, CA (US)

(73) Assignee: Wicue USA INC., Santa Clara, CA (US)

(21) Appl. No.: 18/915,349

(22) Filed: Oct. 14, 2024

Related U.S. Application Data
(60) Provisional application No. 63/520,602, filed on Aug. 18, 2023.

(51) Int. Cl. C09K 19/60; C09K 19/58; G02F 1/1337

(52) U.S. Cl. CPC C09K 19/60; C09K 19/586; G02F 1/133711

(57) ABSTRACT

A dye-doped liquid crystal film includes a first flexible substrate layer, a first conductive layer, a liquid crystal layer, a second conductive layer, and a second flexible substrate layer laminated in this order. A thickness of the liquid crystal layer is d, the first conductive layer and the second conductive layer are configured to apply an electric field to the liquid crystal layer, the liquid crystal layer is mixed with a chiral agent, the chiral agent allows liquid crystal molecules within the liquid crystal layer to be distributed in a helical manner in space, and a helical pitch of the liquid crystal molecules in the helical manner is p, where 0.5≤d/p≤1.5.

### CROSS-REFERENCE TO RELATED APPLICATION

The present disclosure claims priority to and the benefit of US Patent Application No. 63/520,602, filed on August 18, 2023, the disclosure of which is incorporated herein by reference in its entirety.

### TECHNICAL FIELD

The present disclosure relates to a field of liquid crystal display technology, and in particular, to a dye-doped liquid crystal film.

### BACKGROUND

When applying liquid crystal color switching films in fields such as automobiles and building walls, it's often necessary to consider whether there are any adverse factors after the liquid crystal film is combined with the corresponding products in that field. In related technologies, taking the electrochromic glass on automobiles as an example, the electrochromic glass is usually made by attaching a liquid crystal film to car glass or by integrating the liquid crystal film with the car glass during the manufacturing process. The transmittance adjustment of the electrochromic glass is achieved by applying or removing an electric field. Setting a liquid crystal film on the electrochromic glass can effectively protect the privacy inside the car and can also prevent direct sunlight from shining into the car. However, traditional liquid crystal films have a relatively high haze, which leads to a poor visual experience for passengers when applied to car glass and poses certain safety risks to drivers.

### SUMMARY

In view of above, in an aspect, an embodiment of the present disclosure provides a dye-doped liquid crystal film including a first flexible substrate layer, a first conductive layer, a liquid crystal layer, a second conductive layer, and a second flexible substrate layer laminated in this order. A thickness of the liquid crystal layer is d, the first conductive layer and the second conductive layer are configured to apply an electric field to the liquid crystal layer, the liquid crystal layer is mixed with a chiral agent, the chiral agent allows liquid crystal molecules within the liquid crystal layer to be distributed in a helical manner in space, and a helical pitch of the liquid crystal molecules in the helical manner is p, and where 0.5≤d/p≤1.5.

In an embodiment, the dye-doped liquid crystal film further includes a transparent sealing adhesive located at a periphery of the dye-doped liquid crystal film, wherein the sealing adhesive is configured to join the first and second conductive layers and to confine the liquid crystal layer within a cell formed by the first and second conductive layers and the sealing adhesive, and in a thickness direction of the dye-doped liquid crystal film, the first conductive layer, the sealing adhesive, and then the second conductive layer are arranged sequentially.

In an embodiment, a material of the sealing adhesive includes one of epoxy resin, polyurethane acrylate, polyester acrylate, and silicone resin.

In an embodiment, the liquid crystal molecules are of the Guest-Host type, and a mass proportion of dye molecules of the liquid crystal layer is in a range of 3.5% to 4.5%.

In an embodiment, within the liquid crystal layer, a mass proportion of the chiral agent is in a range of 3.5%-4.5%.

In an embodiment, the dye-doped liquid crystal film further includes a plurality of spacers, in a thickness direction of the liquid crystal layer, for at least some of the plurality of spacers, opposing ends of the spacers are in contact with the first and second conductive layers, respectively, and from a center of the liquid crystal layer toward a periphery of the liquid crystal layer, the plurality of spacers are spaced apart.

In an embodiment, each of materials of the first flexible substrate layer and the second flexible substrate layer includes one of PC, PET, PMMA, PVC, PP, PEN, and TAC.

In an embodiment, the thickness range for both the first and second flexible substrate layers is between 0.05 mm and 0.2 mm.

In an embodiment, the dye-doped liquid crystal film further includes a first alignment layer and a second alignment layer, wherein the first alignment layer is located between the first conductive layer and the liquid crystal layer, and the second alignment layer is located between the second conductive layer and the liquid crystal layer.

In an embodiment, wherein when the first and second conductive layers are not powered, a long axis of the liquid crystal molecules in a region adjacent to the first conductive layer forms an angle of 0 to 30° with respect to the first conductive layer, and when the first and second conductive layers are powered, the long axis of the liquid crystal molecules is perpendicular to the first conductive layer.

In an embodiment, when the first and second conductive layers are powered, transmittance of the liquid crystal layer is in a range of 5% to 70%, and when the first and second conductive layers are not powered, the transmittance of the liquid crystal layer is in a range of 0.1% to 15%.

### BRIEF DESCRIPTION OF THE DRAWINGS

FIG. 1 is a schematic diagram showing the distribution of some liquid crystal molecules and dye molecules in a low-haze dye-doped liquid crystal film according to an embodiment of the present disclosure.

FIG. 2 is a schematic block diagram of a dye-doped liquid crystal film according to an embodiment of the present disclosure.

FIG. 3 is a schematic cross-sectional diagram of a dye-doped liquid crystal film according to an embodiment of the present disclosure.

FIG. 4 is a data table illustrating variation of haze and transmittance with voltage in the liquid crystal films in the related art.

FIG. 5 is a curve illustrating the variation of haze with voltage based on FIG. 4.

FIG. 6 is a curve illustrating the variation of transmittance with voltage based on FIG. 4.

FIG. 7 is a data table illustrating the variation of haze and transmittance with voltage in a dye-doped liquid crystal film according to an embodiment of the present disclosure.

FIG. 8 is a curve illustrating the variation of haze with voltage based on FIG. 7.

FIG. 9 is a curve illustrating the variation of transmittance with voltage based on FIG. 7.

List of reference signs: First Flexible Substrate Layer 100, Second Flexible Substrate Layer 110, First Conductive Layer 200, Second Conductive Layer 210, Liquid Crystal Layer 300, Liquid Crystal Molecule 310, Dye Molecules 320, First Alignment Layer 400, Second Alignment Layer 410, Sealing Adhesive 500, Spacer 600.

### DETAILED DESCRIPTION

Hereinafter, Some embodiments of the present disclosure will be described in detail below with reference to the accompanying drawings. The embodiments are described for illustrative purposes only and are not intended to limit the present disclosure. . It should be apparent that the described embodiments are only a portion of, not all of, the embodiments of the present disclosure. Based on the embodiments of the present disclosure, all other embodiments that those skilled in the art obtain without making any creative work fall within the scope of the present disclosure.

Some embodiments of the present disclosure is to provide a low-haze dye-doped liquid crystal film, to address the technical issue of high haze in dye-doped liquid crystal films.

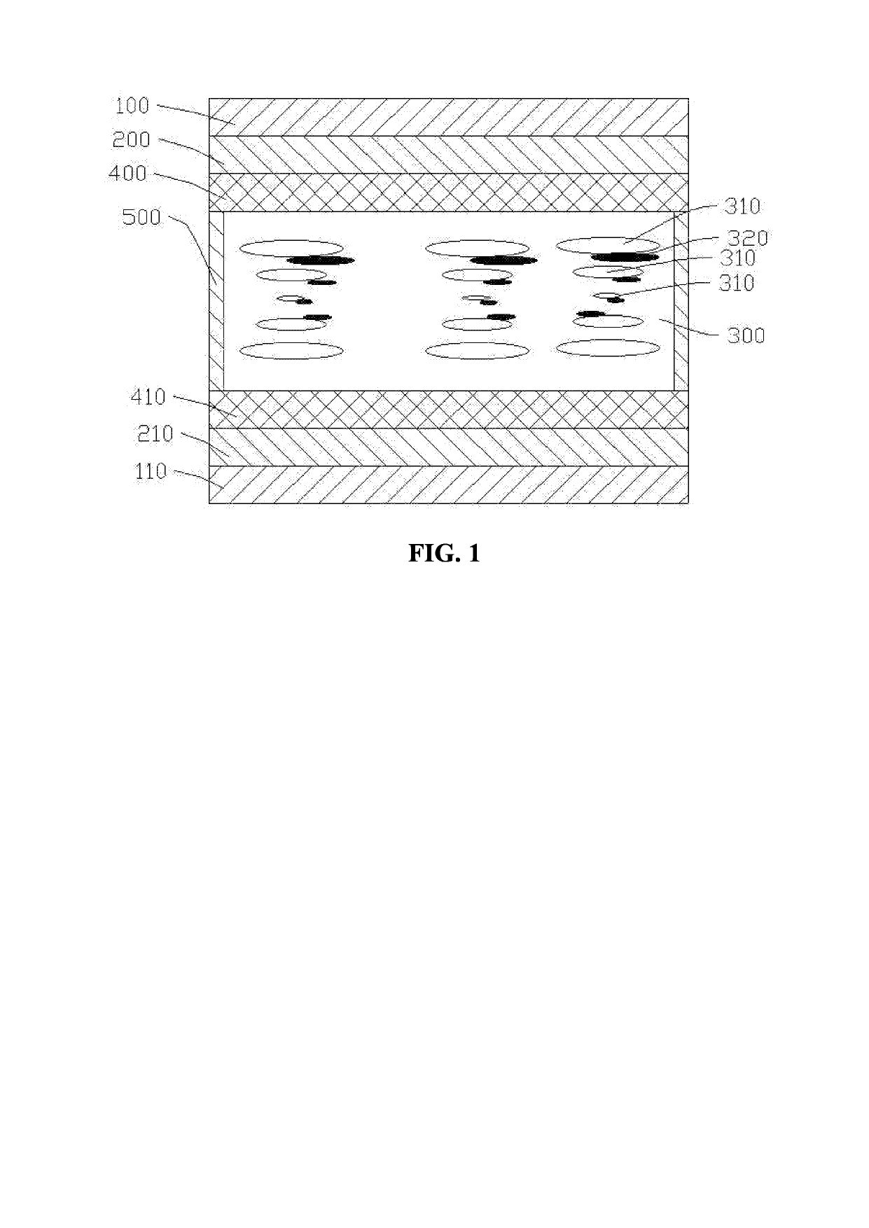

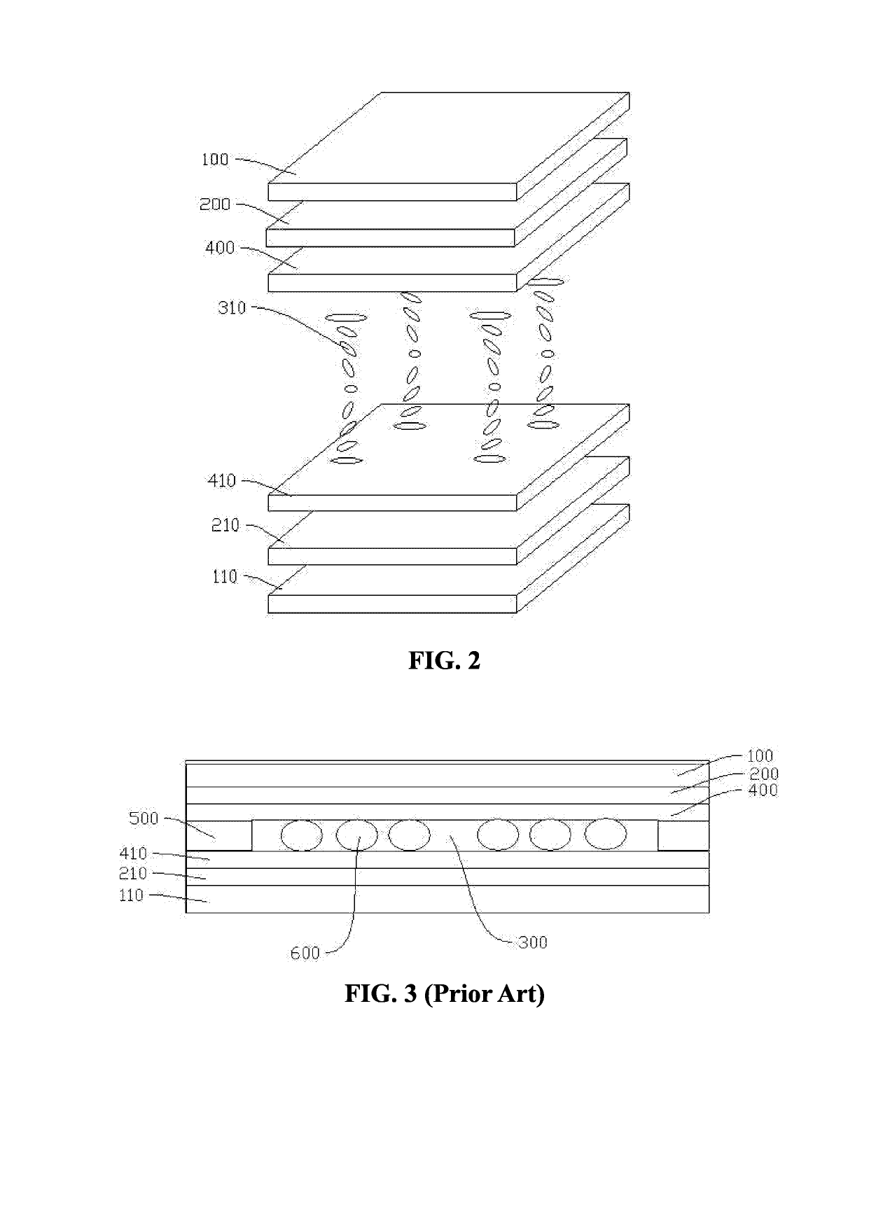

Some embodiment of the present disclosure provides a low-haze dye-doped liquid crystal film. Referring to FIGS. 1 and 3, FIG. 1 shows a schematic diagram showing the distribution of some liquid crystal molecules and dye molecules in a low-haze dye-doped liquid crystal film according to an embodiment of the present disclosure and FIG. 3 shows a schematic cross-sectional diagram of a dye-doped liquid crystal film according to an embodiment of the present disclosure . The low-haze dye-doped liquid crystal film includes the first flexible substrate layer 100, the first conductive layer 200, the liquid crystal layer 300, the second conductive layer 210, and the second flexible substrate layer 110 laminated in this order. The thickness of the liquid crystal layer 300 is denoted as d. The first conductive layer 200 and the second conductive layer 210 are configured to apply an electric field to the liquid crystal layer 300. The liquid crystal layer 300 is mixed with a chiral agent, referring to FIG. 2 (where only liquid crystal molecule 310 is used as a representation). This chiral agent enables the liquid crystal molecules 310 within the layer 300 to form a helical shape in space, where the helical pitch of the liquid crystal molecules is p, and 0.5 ≤ d/p ≤ 1.5.

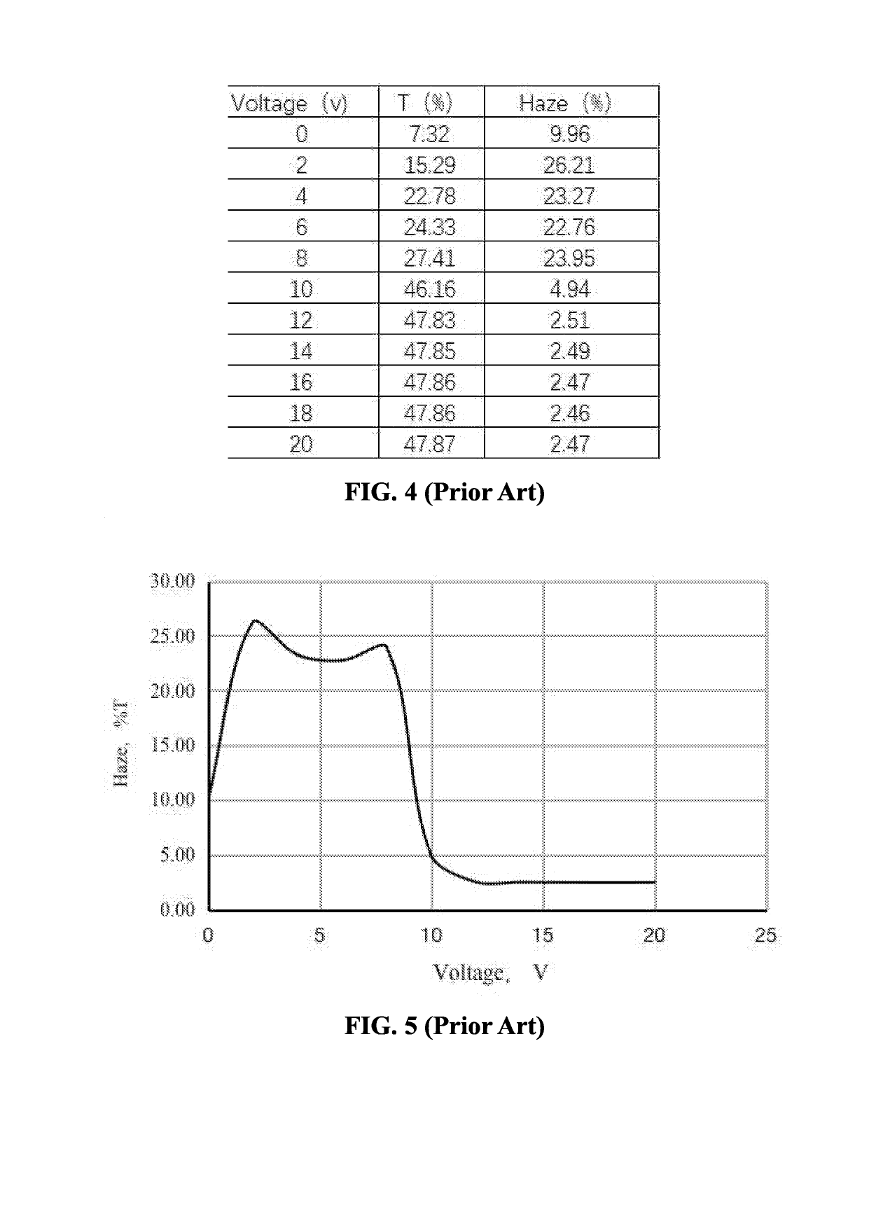

In traditional liquid crystal films, referring to FIG. 5, which shows the haze variation curve of the traditional liquid crystal film with voltage, it can be observed that at lower voltages between the first conductive layer 200 and the second conductive layer 210 when both the first conductive layer 200 and the second conductive layer 210 are powered, the haze of the liquid crystal film is relatively higher. However, when the voltage exceeds 8V (i.e., the inflection point between 5V to 10V in FIG. 5), the haze of the liquid crystal film begins to drop sharply. After the voltage reaches 10V, the haze of the liquid crystal film remains stable. This indicates that the traditional liquid crystal films exhibit higher haze when the electric field applied to the liquid crystal layer 300 is relatively lower, reaching a peak haze value of approximately 26% (as represented by the highest point in FIG. 5). Moreover, after the voltage reaches 10V, the haze of the liquid crystal film still remains at about 2.5%, severely impacting the clarity and visual experience for users. Specifically, referring to FIG. 4, which is a data table for the voltage, the transmittance, and the haze of the low-haze dye-doped liquid crystal film, the haze values are given for various voltages between the first conductive layer 200 and the second conductive layer 210.

In some embodiments of the present disclosure, under the condition that d/p is greater than or equal to 0.5 and less than or equal to 1.5, the haze of the low-haze dye-doped liquid crystal film is relatively lower when the first conductive layer 200 and the second conductive layer 210 are not powered (that is, not supplied with the power). Furthermore, the haze remains minimally affected by the voltage even after the first and second conductive layers are powered (that is, supplied with the power), the haze of the low-haze dye-doped liquid crystal film maintains a value below 2%. Compared to traditional liquid crystal films, the low-haze dye-doped liquid crystal film according to some embodiments of the present disclosure effectively reduces the haze.

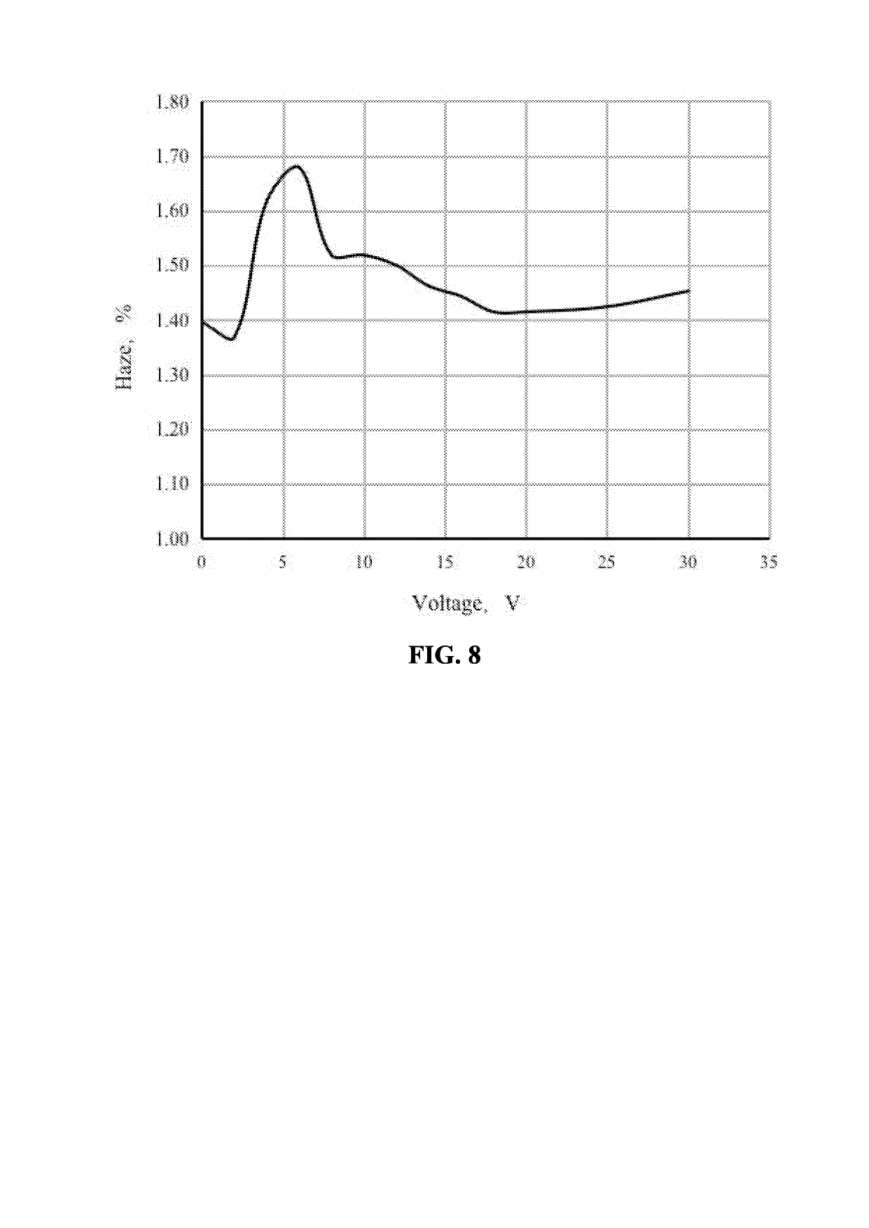

In an embodiment, under the condition that d/p is equal to one, referring to FIGS. 7 and 8, FIG. 7 provides a data table of the variation of haze and transmittance with voltage for the low-haze dye-doped liquid crystal film in some embodiments. FIG. 8 shows a curve illustrating the variation of haze with voltage based on FIG. 7. When the first conductive layer 200 and the second conductive layer 210 are unpowered (i.e., voltage is zero), the haze is 1.40%. When the voltage applied to each of the first conductive layer 200 and the second conductive layer 210 is 2, 4, 6, 8, 10, 12, 14, 16, 18, or 20V, the value of the haze are provided. It can be observed that, under the condition that d/p is equal to one, the haze of the low-haze dye-doped liquid crystal film consistently remains at a lower level, and its change due to voltage variation is minimal.

In some embodiments, referring to FIGS. 1 and 3, the low-haze dye-doped liquid crystal film includes a sealing adhesive 500. The sealing adhesive 500 is transparent and envelopes the outer periphery of the liquid crystal layer 300. Along the thickness direction of the low-haze dye-doped liquid crystal film, the first conductive layer 200, sealing adhesive 500, and the second conductive layer 210 are layered in sequence.

The sealing adhesive 500 possesses excellent sealing capabilities and robust adhesive strength with the flexible substrate layers. The application of the sealing adhesive 500 on the liquid crystal film can prevent the liquid crystal material within the panel from leaking out and also block external contaminants such as air, moisture, and other impurities from entering and polluting the liquid crystal layer. It can be understood that, in some embodiments of the present disclosure, due to the transparent nature of the sealing adhesive 500, the low-haze dye-doped liquid crystal film in some embodiments of the present disclosure can be suitable for the production and development of some bezel-less products, such as bezel-less car windows, and the like.

Furthermore, in some embodiments, the material of the sealing adhesive 500 is one of epoxy resin, polyurethane acrylate, polyester acrylate, or silicone resin.

The epoxy resin has higher adhesive strength and corrosion resistance. The polyurethane acrylate has a rapid curing speed and good water resistance. The polyester acrylate has good weather resistance and ultraviolet (UV) resistance. The silicone resin also possesses good weather resistance and UV resistance.

In some embodiments, the guest-host (GH) liquid crystal is used as the liquid crystal material for the liquid crystal layer 300. However, depending on the display requirements, one can also choose at least one from TN liquid crystals, VA liquid crystals, ECB liquid crystals, or STN liquid crystals as the liquid crystal material for the said liquid crystal layer. The liquid crystal layer 300 employs a GH guest-host type dye-doped liquid crystal, in which a dichroic dye is dissolved in the liquid crystal to form a guest-host relationship, with the liquid crystal as the host and the dichroic dye as the guest. Under the influence of an external electric field, the dye molecules (referred to as 320) rotate in tandem with the liquid crystal molecules. The dichroic dyes exhibit optical anisotropy in light absorption. Based on the relationship between the absorption axis and the molecular axis of the dye molecule 320, the dichroic dyes can be categorized into positive (P-type) dichroic dyes and negative (N-type) dichroic dyes. When a E-vector of light is perpendicular to the optical axis of the dye molecule, the light substantially passes through. However, when the E-vector of the light is parallel to the optical axis of the dye molecule, the light is substantially absorbed. The former type of the dye molecule is considered a positive dichroic dye molecule, whereas the negative dichroic dye exhibits the opposite behavior. Relying on the characteristics of positive and negative dye molecules to absorb or transmit light, the transmittance of the liquid crystal layer 300 can be adjusted. Consequently, this type of liquid crystal is referred to as a guest-host type liquid crystal. Because the guest-host type liquid crystals can operate without attaching a polarizing film, and utilize the selective light transmittance of the chromatic dye, they can meet the performance requirements of the liquid crystal layer 300, allowing for the adjustment of brightness levels while maintaining high transparency. Furthermore, the color can be modified when the liquid crystal layer 300 is in a dark state by adjusting the color of the dichroic dye. In an embodiment, in the liquid crystal layer 300, the mass ratio of the dye molecule 320 ranges from 3.5% to 4.5%.

In some embodiments, within the liquid crystal layer 300, the mass ratio of the chiral agent ranges from 3.5% to 4.5%.

When the chiral agent is introduced into the liquid crystal molecule 310, it affects the helical shape of the liquid crystal molecule 310, causing the liquid crystal molecule 310 to selectively reflect incident light with the wavelength thereof corresponding to the helical pitch the helical shape of the liquid crystal molecule 310.

In some embodiments, as shown in FIG. 3, the low-haze dye liquid crystal film further includes a plurality of spacers 600. Along the thickness direction of the liquid crystal layer 300, opposing ends of each of at least some of the spacers 600 are in contact with the first and second conductive layers 200 and 210, respectively, thereby maintaining the thickness of the liquid crystal layer 300. From the center of the liquid crystal layer 300 toward the periphery of the liquid crystal layer 300, the plurality of spacers 600 are spaced apart.

It can be understood that when the low-haze dye-doped liquid crystal film is laid flat (taking the second flexible substrate layer 110 being below the first flexible substrate layer 100 as an example), both the first flexible substrate layer 100 and the first conductive layer 200 are positioned above the liquid crystal layer 300 and the liquid crystal layer 300 is affected by gravity, a collapse may occur in the center of the low-haze dye-doped liquid crystal film. This could consequently affect the alignment and orientation of the liquid crystal molecules 310 in the liquid crystal layer 300.

The design of the spacers 600 effectively addresses this drawback, prevents the risk of internal collapse in the low-haze dye liquid crystal film, and prolongs its service life.

In an example, during the formation of the liquid crystal layer 300, spraying the spacers 600 to the liquid crystal layer 300 can prevent the first conductive layer 200 and the second conductive layer 210 from coming into contact after the formation of the low-haze dye liquid crystal film.

In some embodiments, the materials of the first flexible substrate layer 100 and the second flexible substrate layer 110 may include one of the following: PC, PET, PMMA, PVC, PP, PEN, or TAC.

In some embodiments, the thickness of each of the first flexible substrate layer 100 and the second flexible substrate layer 110 is between 0.05 mm and 0.2 mm.

In some embodiments, referring to FIGS. 1 and 3, the low-haze dye-doped liquid crystal film includes a first alignment layer 400 and a second alignment layer 410. The first alignment layer 400 is positioned between the first conductive layer 200 and the liquid crystal layer 300, and the second alignment layer 410 is situated between the second conductive layer 210 and the liquid crystal layer 300. The first alignment layer 400 and the second alignment layer 410 are designed to align the liquid crystal molecules 310 within the liquid crystal layer 300, such that, in the state where the first conductive layer 200 and the second conductive layer 210 are not powered, the liquid crystal molecules 310 within the liquid crystal layer 300 may have an initial fixed direction. This ensures that the long axis of each liquid crystal molecule 310 in the region adjacent to the first conductive layer forms an angle ranging between 0 to 30° with the first conductive layer 200. Alternatively, after being oriented, the long axis of the liquid crystal molecule 310 is parallel to the first alignment layer 400, such that the initial light transmittance of the low-haze dye doped liquid crystal film is minimized.

Furthermore, in some embodiments, when the first conductive layer 200 and the second conductive layer 210 are not powered, the long axis of the liquid crystal molecule 310 in the region adjacent to the first conductive layer 200 forms an angle bewteen 0 to 30° with the first conductive layer 200. When the first conductive layer 200 and the second conductive layer 210 are powered, the long axis of the liquid crystal molecule 310 is primarily perpendicular to the first conductive layer 200. When the first conductive layer 200 and the second conductive layer 210 are not powered, the long axis of the liquid crystal molecule 310 is parallel to the orientation layer, and the incident light is parallel to the dye absorption axis, thereby resulting in the lowest light transmittance of the low-haze dye doped liquid crystal film, and creating a dark state. Conversely, when the first conductive layer 200 and the second conductive layer 210 are powered, the long axis of the liquid crystal molecule 310 is perpendicular to the orientation layer, and the incident light is perpendicular to the dye absorption axis, thereby resulting in the highest light transmittance of the low-haze dye doped liquid crystal film, and creating a bright state.

In some embodiments, when the first conductive layer 200 and the second conductive layer 210 are powered, the transmittance of the liquid crystal layer 300 is in an range of 5% to 70%. When the first conductive layer 200 and the second conductive layer 210 are not powered, the transmittance of the liquid crystal layer 300 is in an range of 0.1%-15%.

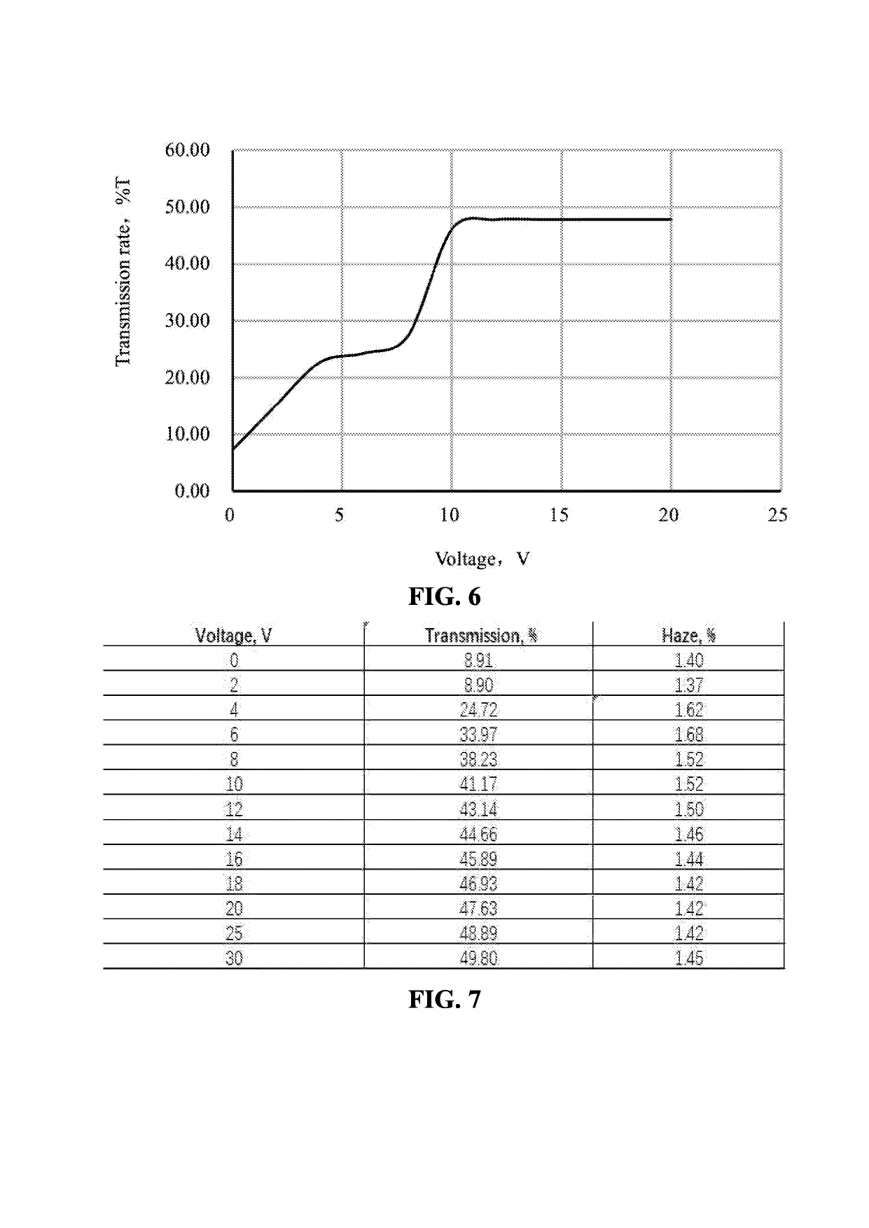

In traditional liquid crystal films, referring to FIGS. 4 and 6, FIG. 6 illustrates the variation curve of transmittance with voltage in traditional liquid crystal films. When the voltage between the first conductive layer 200 and the second conductive layer 210 is 2V, 4V, 6V, 8V, 10V, 12V, 14V, 16V, 18V, 20 V, the transmittance of the liquid crystal film is 7.32%, 15.29%, 22.78%, 24.33%, 27.41%, 46.16%, 47.83%, 47.85%, 47.86%, 47.86%, and 47.87%, respectively.

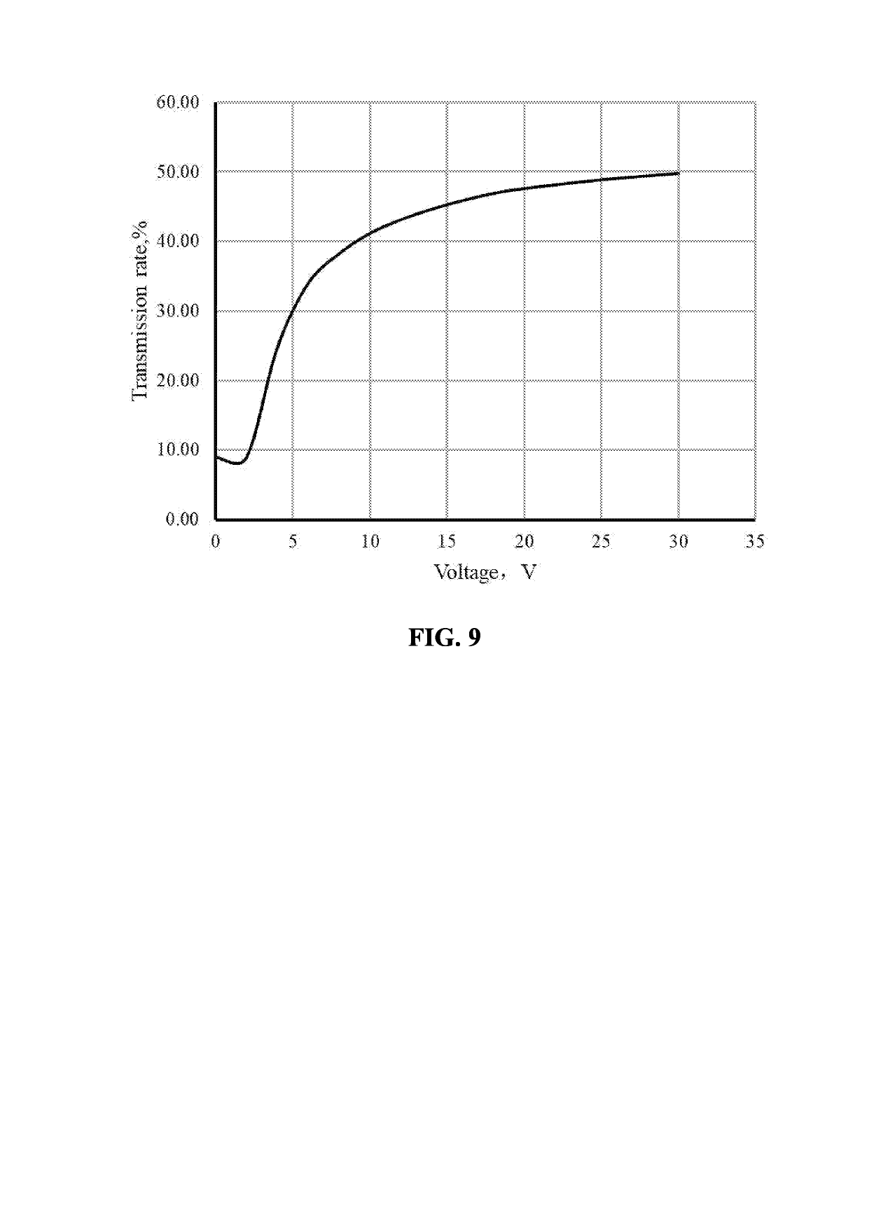

However, in some embodiments of the present disclosure for the low-haze dye-doped liquid crystal film, taking d/p is equal to as an example and referring to FIGS. 7 and 9, FIG. 9 shows a curve of the variation of transmittance with voltage. When the voltage between the first conductive layer 200 and the second conductive layer 210 is 2V, 4V, 6V, 8V, 10V, 12V, 14V, 16V, 18V, 20 V, the transmittance of the liquid crystal film is 8.91%, 8.90%, 24.72%, 33.97%, 38.23%, 41.17%, 43.14%, 44.66%, 45.89%, 46.93%, and 47.63%, respectively. By comparison, it can be observed that, after adjusting d/p between 0.5 to 1.5 in some embodiments, the transmittance of the low-haze dye-doped liquid crystal film may be effectively increased. Moreover, when the voltage between the first conductive layer 200 and the second conductive layer 210 is relatively lower, the sensitivity of the liquid crystal molecules 310 inside the film to the electric field is also higher. This means that the better adjustment the transmittance of the low-haze dye-doped liquid crystal film may be realized under a lower voltage between the first conductive layer 200 and the second conductive layer 210. In traditional liquid crystal films, only after the voltage is considerably increased can the transmittance of the liquid crystal film be significantly enhanced. It can be seen that the embodiments of the present disclosure may adjust the higher transmittance of the low-haze dye-doped liquid crystal film with a smaller voltage, thus significantly reducing the power consumption of the low-haze dye-doped liquid crystal film.

Compared to the existing technology, the beneficial effects of the present disclosure are as follows: within the range where 0.5 ≤ d/p ≤ 1.5, the haze of the dye-doped liquid crystal film according to some embodiment of the present disclosure, both in powered and unpowered states, is lower than the haze of traditional liquid crystal films.

It should be noted that the technical solutions of the various embodiments of the present disclosure can be combined with each other. However, the combination must be based on the premise that those skilled in the art can implement it. If the combination of technical solutions leads to contradictions or becomes unfeasible, such a combination should be considered non-existent and is not within the scope of protection sought by the present disclosure.

What has been described above represents only a portion or some embodiments of the present disclosure. Neither the text nor the attached figures should restrict the scope of protection for the present disclosure. Any equivalent structural modifications made under the overall conception of the present disclosure, or the direct/indirect application in other related technical fields, are all included within the scope of protection of the present disclosure.

What is claimed is:

1. A dye-doped liquid crystal film, comprising a first flexible substrate layer, a first conductive layer, a liquid crystal layer, a second conductive layer, and a second flexible substrate layer laminated in this order,
wherein a thickness of the liquid crystal layer is d, the first conductive layer and the second conductive layer are configured to apply an electric field to the liquid crystal layer, the liquid crystal layer is mixed with a chiral agent, the chiral agent allows liquid crystal molecules within the liquid crystal layer to be distributed in a helical manner in space, and a helical pitch of the liquid crystal molecules in the helical manner is p, and wherein 0.5≤d/p≤1.5.

2. The dye-doped liquid crystal film of claim 1, further comprising a transparent sealing adhesive located at a periphery of the dye-doped liquid crystal film, wherein the sealing adhesive is configured to join the first and second conductive layers and to confine the liquid crystal layer within a cell formed by the first and second conductive layers and the sealing adhesive, and in a thickness direction of the dye-doped liquid crystal film, the first conductive layer, the sealing adhesive, and then the second conductive layer are arranged sequentially.

3. The dye-doped liquid crystal film of claim 2, wherein a material of the sealing adhesive includes one of epoxy resin, polyurethane acrylate, polyester acrylate, and silicone resin.

4. The dye-doped liquid crystal film of claim 1, wherein the liquid crystal molecules are of the guest-host type, and a mass proportion of dye molecules of the liquid crystal layer is in a range of 3.5% to 4.5%.

5. The dye-doped liquid crystal film of claim 1, wherein within the liquid crystal layer, a mass proportion of the chiral agent is in a range of 3.5%-4.5%.

6. The dye-doped liquid crystal film of claim 1, further comprising a plurality of spacers, in a thickness direction of the liquid crystal layer, for at least some of the plurality of spacers, opposing ends of the spacers are in contact with the first and second conductive layers, respectively, and from a center of the liquid crystal layer toward a periphery of the liquid crystal layer, the plurality of spacers are spaced apart.

7. The dye-doped liquid crystal film of claim 1, wherein each of materials of the first flexible substrate layer and the second flexible substrate layer includes one of PC, PET, PMMA, PVC, PP, PEN, and TAC.

8. The dye-doped liquid crystal film of claim 1, wherein a thickness of each of the first flexible substrate layer and the second flexible substrate layer is in a range of 0.05 mm to 0.2 mm.

9. The dye-doped liquid crystal film of claim 1, further comprises a first alignment layer and a second alignment layer, wherein the first alignment layer is located between the first conductive layer and the liquid crystal layer, and the second alignment layer is located between the second conductive layer and the liquid crystal layer.

10. The dye-doped liquid crystal film of claim 1, wherein when the first and second conductive layers are not powered, a long axis of the liquid crystal molecules in a region adjacent to the first conductive layer forms an angle of 0 to 30° with respect to the first conductive layer, and when the first and second conductive layers are powered, the long axis of the liquid crystal molecules is perpendicular to the first conductive layer.

11. The dye-doped liquid crystal film of claim 10, wherein when the first and second conductive layers are powered, transmittance of the liquid crystal layer is in a range of 5% to 70%, and when the first and second conductive layers are not powered, the transmittance of the liquid crystal layer is in a range of 0.1% to 15%.
